(19) United States
(12) Patent Application Publication
(10) Pub. No.: US 2013/0290623 A1
(43) Pub. Date: Oct. 31, 2013

(54) COMPUTER AND METHOD FOR CONTROLLING COMPUTER

(71) Applicants: Etsutaro Akagawa, Kawasaki (JP); Takaki Nakamura, Ebina (JP); Masayuki Yamamoto, Sagamihara (JP)

(72) Inventors: Etsutaro Akagawa, Kawasaki (JP); Takaki Nakamura, Ebina (JP); Masayuki Yamamoto, Sagamihara (JP)

(73) Assignee: Hitachi ,Ltd.

(21) Appl. No.: 13/510,813

(22) PCT Filed: Apr. 25, 2012
(86) PCT No.: PCT/JP2012/002833

§ 371 Date: May 18, 2012

(51) Int. Cl. G06F 12/16; G06F 12/02

(52) U.S. Cl. 711/112; 711/162; 711/E12.103; 711/E12.002

(57) ABSTRACT

Recently, along with the increase in the importance of data protection, there are increasing demands for constructing a computer system capable of protecting data even when widespread disaster occurs. In order to reduce the risk of data loss even when widespread disaster occurs, the present invention computes the risk of data loss for each replication relationship of data (combination of storage subsystems storing the same data), and allocates data so that the risks of losing data of all replication relationships are optimized.

### TECHNICAL FIELD

The present invention relates to a computer and a method for controlling a computer preferable for computing various data loss risks.

### BACKGROUND ART

Computer systems are indispensable in companies, public agencies and other organizations, and it is especially difficult to recover the computer system if data loss used in the computer systems occurs, but it is also important to protect the data from the viewpoint of internal control and compliance. Recently, there are increasing demands for storage systems capable of protecting data even when widespread disaster such as earthquakes, typhoons and terrorism occurs, or when power failure and other failures occur.

Recently, in addition, data is stored widely in public storage subsystems such as cloud storages, and on the other hand, the amount of confidential information and other data that cannot be stored outside the organization is increasing, so that there are increasing demands for a storage system capable of preventing leakage of information while utilizing public storage subsystems.

As disclosed in patent literature 1 related to the method for protecting data, data was copied to multiple storage subsystems according to the prior art. By adopting such technique, it is possible to restore data using other storage subsystems even if data in a single storage subsystem is lost due to a disaster.

Further, non-patent literature 1 discloses an art of considering disaster risks of a single storage subsystem upon determining the allocation of data. By adopting such technique, it becomes possible to reduce the risk of losing data even when disaster occurs.

### CITATION LIST

### Patent Literature

PTL 1: Japanese Patent Application Laid-Open Publication No. 2011-34164 (US Patent Application Publication No. 2011/0029748)

### Non Patent Literature

NPL 1: Disaster Tolerant Data Allocation Model on Wide Area Network (IPSJ SIG Technical Report Vol. 2008 No. 17 pp. 169-172)

### SUMMARY OF INVENTION

### Technical Problem

The art of copying data to multiple storage subsystems as disclosed in patent literature 1 determines the arrangement in which data is copied based on the performance and the capacity of storage subsystems, and it lacked to consider disaster risks. Therefore, there was a problem in that the prior art storage subsystems had not considered the risk of occurrence of widespread failure by which all the storage subsystems having data copied therein are damaged by disaster and all data are lost.

Further, the art disclosed in non patent literature 1 considering disaster risks of a single storage subsystem lacked to consider replicating data in multiple storage subsystems, so that there was a drawback in that data had not been allocated in an optimum manner for minimizing the risk of data loss as a whole computer system.

The present invention aims at solving the above problems. The object of the present invention is to construct a computer system for optimizing the allocation (replication relationship) of data and reducing data loss risks in a storage subsystem by considering the replication of data even when widespread disaster occurs and multiple storage subsystems are damaged by the disaster.

### Solution to Problem

In order to solve the problems mentioned above, the present invention provides a computer coupled to three or more storage subsystems, wherein the computer is composed of an input unit for entering information; and a control unit; and wherein based on the information, the control unit is caused to compute a data loss risk for each combination of storage subsystems when two or more storage subsystems out of the three or more storage subsystems are combined to store the same data, and determine a destination of arrangement of the replicated data based on the combination of the storage subsystems in which the data loss risk becomes smallest.

Further according to the present invention, the computer is caused to store each storage capacity information of the three or more storage subsystems respectively in a memory device disposed on the computer or a disk array subsystem coupled to the computer; and determine the destination of arrangement of the replicated data so that the respective storage capacities of the three or more storage subsystems are not exceeded. Moreover, the computer is caused to manage the data loss risk allowed for each data; and determine the allocation destination of the replicated data so as not to exceed the allowable data loss risk.

Further according to the present invention, the computer is caused to compute the risk for each of two or more data loss causes. Moreover, the computer is caused to gather data loss causes so that the number of causes equals the number of replication of data when the number of replication of data is smaller than the number of data loss causes. Moreover, the computer comprise a control unit for calculating fees and the control unit calculates fees for replicating data according to the risk of losing data.

Even further, the computer comprises a control unit for managing priority of each data. Moreover, the computer comprises a control unit for managing data type and storage subsystem type.

### Advantageous Effects of Invention

According to the present invention, a system administrator is enabled to easily construct a computer system having a low data loss risk even when widespread disaster occurs.

### BRIEF DESCRIPTION OF DRAWINGS

FIG. 1 is a block diagram showing a basic configuration of a computer system according to the present invention.

FIG. 2 is a view showing a configuration example of a data loss cause table.

FIG. 3 is a view showing a configuration example of a data loss risk table.

FIG. 4 is a view showing a configuration example of a data replication configuration management table.

FIG. 5 is a block diagram illustrating an internal configuration of the storage subsystem.

FIG. 6 is a view showing a configuration example of a management screen for updating the data loss cause table.

FIG. 7 is a view showing a configuration example of a management screen for setting up causes to be considered for each replication.

FIG. 8 is a flowchart illustrating a procedure for creating a data loss risk table.

FIG. 9 is a view showing a configuration example of a storage subsystem management table according to a method for optimizing data loss risks according to embodiment 1.

FIG. 10 is a view showing a configuration example of a storage subsystem management table for computing an optimum combination of storage subsystems considering storage capacity rates according to embodiment 1.

FIG. 11 is a block diagram illustrating a configuration of a computer system according to embodiment 2.

FIG. 12 is a view showing a configuration example of a management screen according to embodiment 2.

FIG. 13 is a flowchart showing a procedure for computing fees for each replication.

FIG. 14 is a block diagram illustrating a configuration of a computer system according to embodiment 3.

FIG. 15 is a view showing a configuration example of a data type table.

FIG. 16 is a view showing a configuration example of a storage subsystem type table.

FIG. 17 is a view showing a configuration example of a storage subsystem management table according to the method for optimizing the data loss risk according to embodiment 3.

FIG. 18 is a view showing one example of a data loss risk table.

FIG. 19 is a view showing one example of an allowable data loss risk table.

FIG. 20 is a view showing an example of the screen interface for entering an allowable total risk value, a maximum number of replications, and a priority of each data.

FIG. 21 is a flowchart showing the procedure for calculating an optimum replication an arrangement of the replicated data.

FIG. 22 is a view showing one example of a data loss risk table after appending all combinations constituting two storage subsystems and their total risk values based on the examples illustrated in FIGS. 18 and 19.

FIG. 23 is a view showing one example of a data loss risk table after appending all combination constituting three storage subsystems and their total risk values based on the examples illustrated in FIGS. 18 and 19.

### DESCRIPTION OF EMBODIMENTS

Now, the preferred embodiments of the present invention will be described with reference to the drawings. In the following description, various information are referred to as “management table” and the like, but the various information can be expressed by data structures other than tables. Further, the “management table” can also be referred to as “management information” to show that the information does not depend on the data structure.

The processes are sometimes described using the term “program” as the subject. The program is executed by a processor such as an MP (Micro Processor) or a CPU (Central Processing Unit) for performing determined processes. A processor can also be the subject of the processes since the processes are performed using appropriate storage resources (such as memories) and communication interface devices (such as communication ports). The processor can also use dedicated hardware in addition to the CPU. The computer program can be installed to each computer from a program source. The program source can be provided via a program distribution server or a storage media, for example.

Each element, such as each table, can be identified via numbers, but other types of identification information such as names can be used as long as they are identifiable information. The equivalent elements are denoted with the same reference numbers in the drawings and the description of the present invention, but the present invention is not restricted to the present embodiments, and other modified examples in conformity with the idea of the present invention are included in the technical range of the present invention. The number of each component can be one or more than one unless defined otherwise.

### First Embodiment

### Risk Value Calculation and Optimum Data Allocation

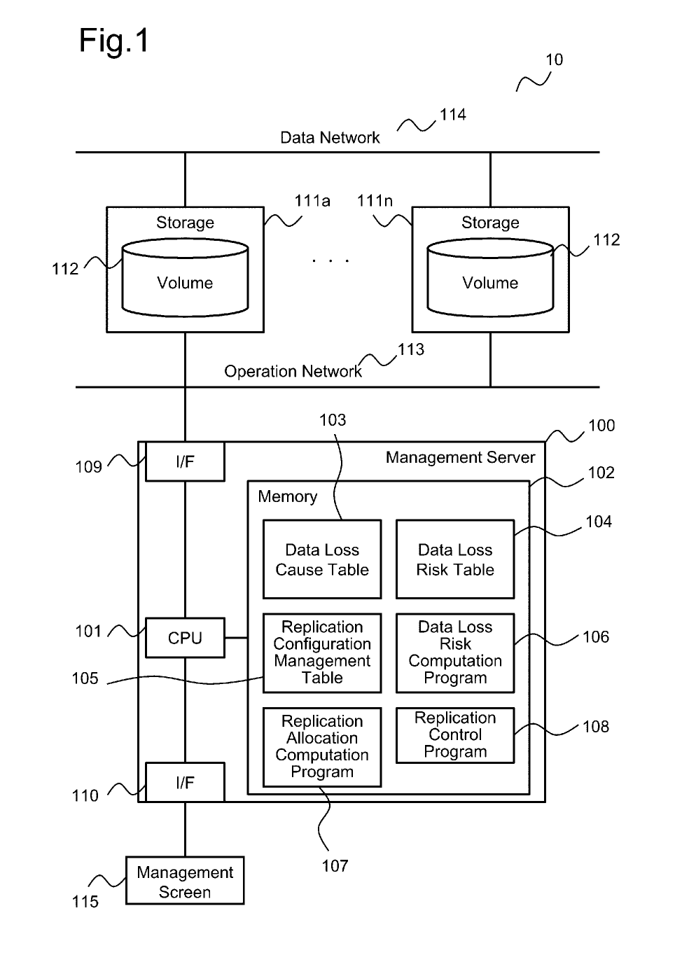

Now, a first embodiment for performing the present invention will be described with reference to FIGS. 1 through 8 according to a first embodiment of the present invention. FIG. 1 is a block diagram showing a configuration of a basic computer system according to the present invention. The outline of a basic computer system to which the present invention is applied is described with reference to FIG. 1.

### <Risk Value Computation>

A computer system 10 is composed of a management server 100 and two or more storage subsystems 111 (storage subsystems 111a through 111n). The management server 100 is composed of a CPU 101, a memory 102, an interface 109 for coupling to the operation network 113 (hereinafter referred to as operation I/F 109), and an interface 110 for coupling to a management screen 115 (hereinafter referred to as screen I/F 110).

The memory 102 has arranged therein a data loss cause table 103, a data loss risk table 104, a replication configuration management table 105, a data loss risk computation program 106, a replication configuration computation program 107, and a replication control program 108, wherein the CPU 101 executes the various programs located in the memory 102.

The operation network 113 is a network for the management server 100 to operate the storage subsystems 111, a preferable example of which is an Ethernet (Registered Trademark). A data network 114 is a network for transferring data among multiple storage subsystems 111, preferable example of which are the Ethernet, a fiber channel or the internet. The data network 114 can also constitute the same network as the operation network 113.

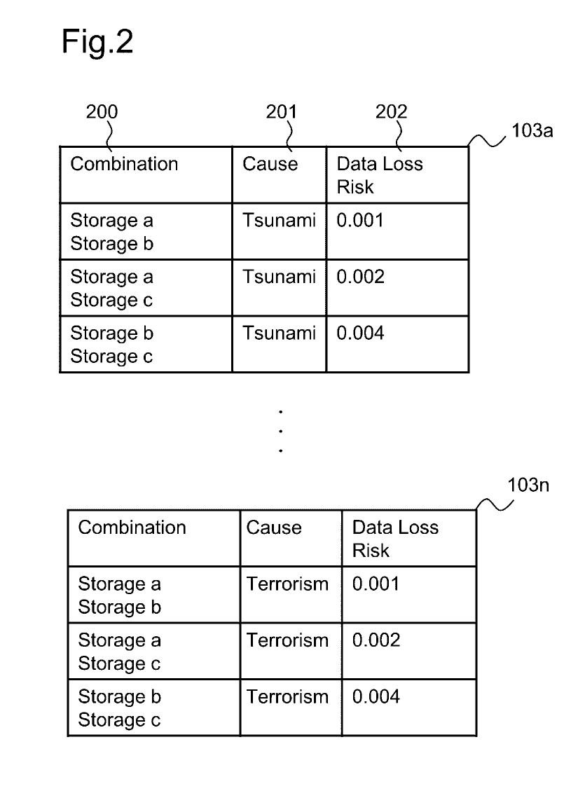

FIG. 2 shows one example of a data loss cause table 103. The data loss cause table 103 at least includes a combination 200 of two or more storage subsystems 111, a cause 201 of occurrence of data loss, and a risk 202 of losing data by the cause 201 in such combination of storage subsystems. Now, if the value of the risk 202 is high, it means that the data loss probability is high. Further, tables can be formed for each cause (tables 103a through 103n).

One example of the cause of data loss is a large-scale earthquake. By taking this cause into consideration, it becomes possible to reduce the risk of having multiple storage subsystems 111 located in nearby areas and having all the storage subsystems 111 damaged by the earthquake so that it is no longer possible to provide continuous services. The data loss risk according to the present cause can be determined to be high if the distance between storage subsystems 111 is close.

Another example of the cause of data loss is a large-scale tsunami. By taking this cause into consideration, it becomes possible to reduce the risk of having multiple storage subsystems 111 located in coastline areas and having all the storage subsystems 111 damaged by the tsunami so that it is no longer possible to provide continuous services. The data loss risks by the present cause can be determined to be high if the altitudes of all the storage subsystems 111 shown in combination 200 are low.

Another example of the cause of data loss is terrorism. By taking this cause into consideration, it becomes possible to reduce the risk of having multiple storage subsystems 111 located in a city subjected to terrorist attack and having all the storage subsystems damaged by terrorism so that it is no longer possible to provide continuous services. The data loss risks by the present cause can be determined to be high if all the storage subsystems 111 shown in combination 200 are located in heavily-populated cities.

Yet another example of the cause of data loss is power failure caused by power companies. By taking this cause into consideration, it becomes possible to reduce the risk of having the storage subsystems 111 stop due to power failure and losing a portion of the data in operation. The data loss risks by the present cause can be determined to be high if all the storage subsystems 111 are located in cities having power supplied from the same power company.

Another example of the case of data loss is the outage of service provided by an internet service provider. By taking this cause into consideration, it becomes possible to reduce the risk of not being able to access storage subsystems 111 due to service outage and losing a portion of the data in operation. The data loss risks by the present cause can be determined to be high if all the storage subsystems 111 are connected to the same internet service provider.

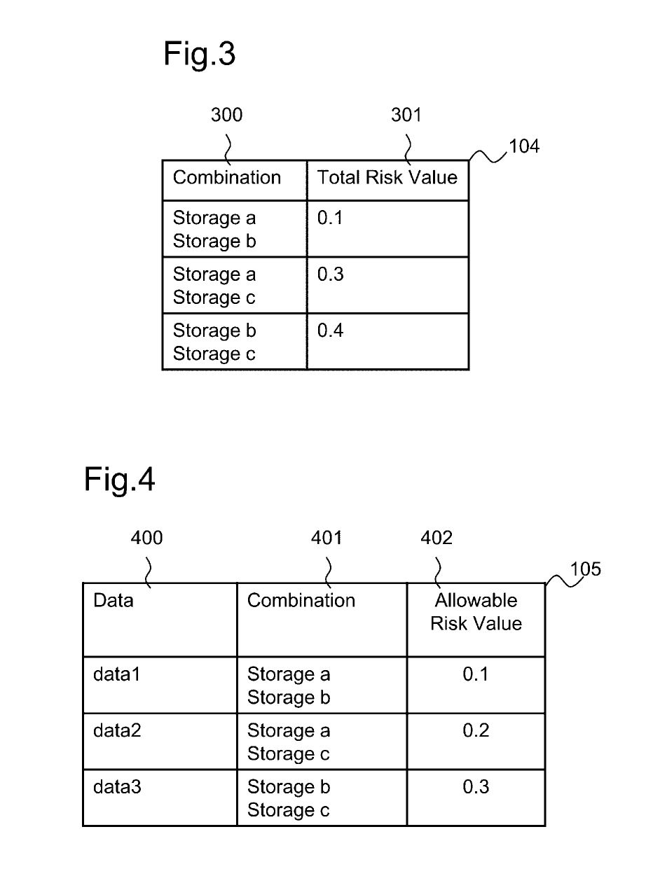

FIG. 3 shows one example of a data loss risk table 104. The data loss risk table 104 includes at least a combination 300 of two or more storage subsystems 111, and a total risk value 301 totalizing one or more causes of data loss and computing the risk of data loss. The combination 300 can also contain same storage subsystem 111. In this case, the total risk value 301 indicates the risk of data loss of the single storage subsystem 111.

The data loss risk table 104 is used for determining an optimum replication destination, but the number of tables can be two or more according to the number of replications of data. For example, if the number of replication of data is two, two data loss risk tables 104 are created, wherein the first table stores the data loss risk caused by tsunami, and the second table stores the data loss risk caused by two causes, terrorism and earthquake, so that the replication relationship can be constructed so as to reduce the data loss risks for each cause.

FIG. 4 shows an example of a replication configuration management table 105. The replication configuration management table 105 includes at least a data 400 which is the target of replication and a combination 401 of two or more storage subsystems 111, and can further include an allowable risk value 402 with respect to the data 400.

In the example illustrated in FIG. 4, a replication source and a replication destination are not clearly shown in combination 401, but it is possible to adopt a format in which the combination is specified via a digraph in which the replication source and the replication destination are clearly defined. Further, according to the example shown in FIG. 4, the data 400 is clearly defined, but the data does not have to be clearly defined. In that case, all the data stored in the storage subsystems shown in combination 401 becomes the target. Further, the risk value 402 can be entered by the administrator when necessary on the management screen 112 via the data loss risk computation program 106.

Further, the risk value 402 can be entered by the administrator when necessary on the management screen 112 via the data loss risk computation program 106.

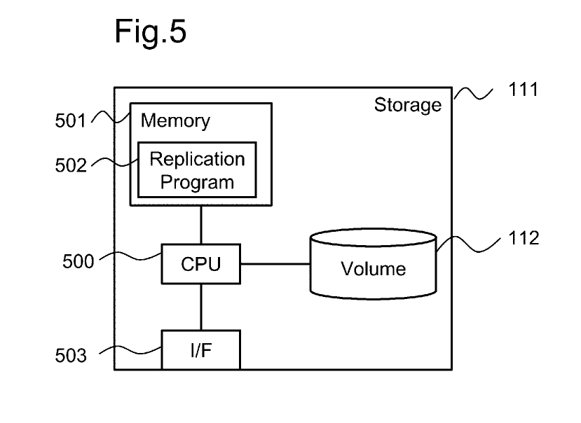

FIG. 5 shows the configuration of a storage subsystem 111 according to the present invention. The storage subsystem 111 is composed of a volume 112 for storing data, a CPU 500, a memory 501, a replication program 502 stored in the memory 501, an interface 503 (operation I/F 403) for connecting to the operation network 113, and an interface 504 for connecting to a data network 114, wherein the CPU 500 executes a replication program 502.

Further, it is also possible to adopt a structure in which the various tables and programs stored in the memory 102 are stored in the memory 501, and that the CPU 500 executes the respective programs. The replication program 502 communicates via a data network 114 with the replication programs 502 of other storage subsystems 111, and replicates the data stored in the volume 112 to other storage subsystems 111. The unit of replication of data can be blocks or files.

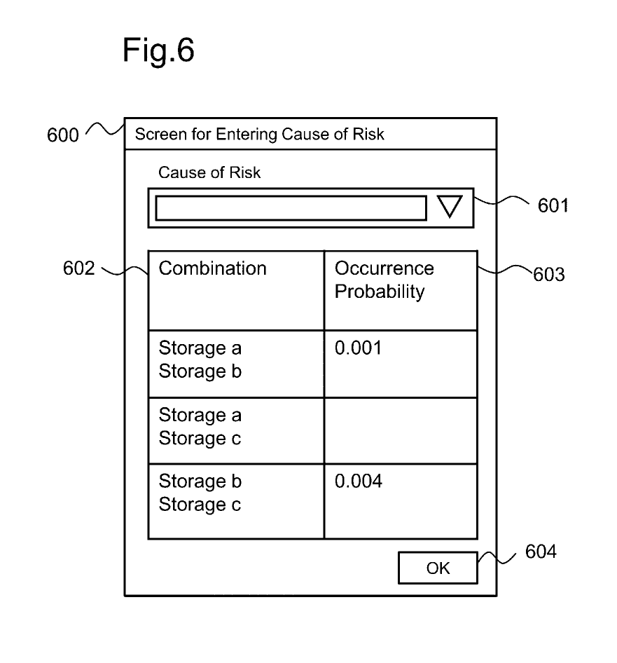

FIG. 6 is a view showing one example of a screen interface for entering the cause of data loss and the occurrence probability thereof for each combination of storage subsystems. The screen interface at least includes an entry field 601 for entering the name of the cause of data loss, a column 602 showing the combination of storage subsystems, and an entry field 603 for entering the probability of occurrence of cause of data loss for each combination of storage subsystems. The entry field 601 should preferably be a pull-down menu, capable of displaying a list of causes 201 of the data loss cause table 103.

Further, it is preferable to have a list of combinations 200 (combinations of storage subsystems) of the data loss cause tables 103 displayed in the column 602. It is preferable to display the contents of occurrence of risk 202 of the cause of data loss (risk value) in the entry field 603.

When an administrator enters the cause of data loss and the known data loss risk for each combination, a data loss risk computation program searches a column corresponding to the entered cause from the data loss cause table 103, and updates the risk 202 for each combination 200. If a new cause of data loss and combination are entered, a new row is added to the data loss risk table 103.

An example is shown in FIG. 6 in which the administrator enters a known data loss risk, but it is also possible to adopt a configuration in which the management server 100 has a program for automatically calculating the data loss risk based on a GPS information of the storage subsystem 111 or the like, and that the program can update each column of the data loss cause table 103.

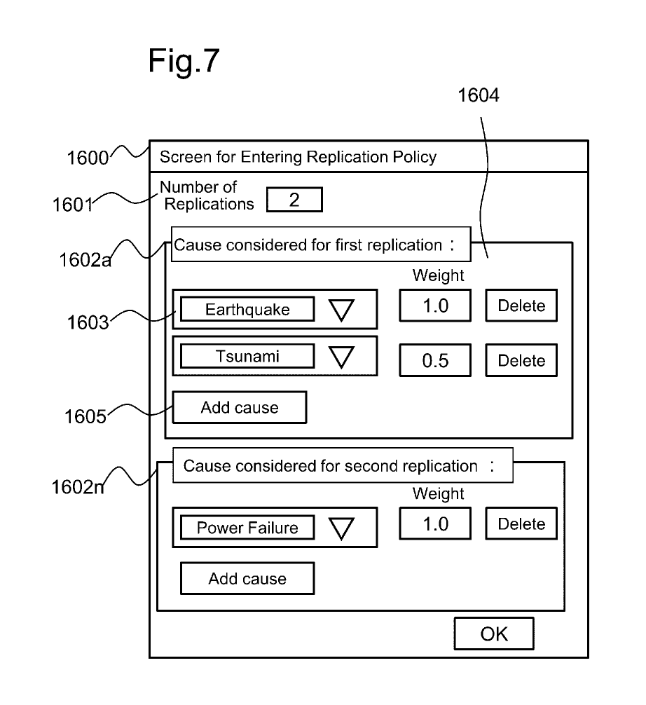

FIG. 7 shows one example of a screen interface for entering a data replication number and the data loss risk to be considered for each replication. The screen interface includes at least an entry field 1601 for entering the number of replications of data, and can further include an area 1602 for entering a cause of data loss and the like to be considered for each replication, an entry field 1603 for entering the cause of data loss to be considered, and a weight 1604 of the cause in the relevant replication.

Area 1602 should preferably show the same number of screens as the number of replications entered in the entry field 1601. Further, the entry field 1603 should preferably be a pull-down menu capable of displaying a list of causes 201 of the data loss cause table 103.

In the present screen, it is possible to designate only the number of replications of data. In that case, the system automatically sets up the data loss risk to be considered. For example, if there are four types of causes 201 and the number of replications is 2, the first and second data loss causes are considered for the first replication destination and the third and fourth data loss causes are considered for the second replication destination. As described, an automated process for dividing the number of causes equally by the set number of replications can be considered.

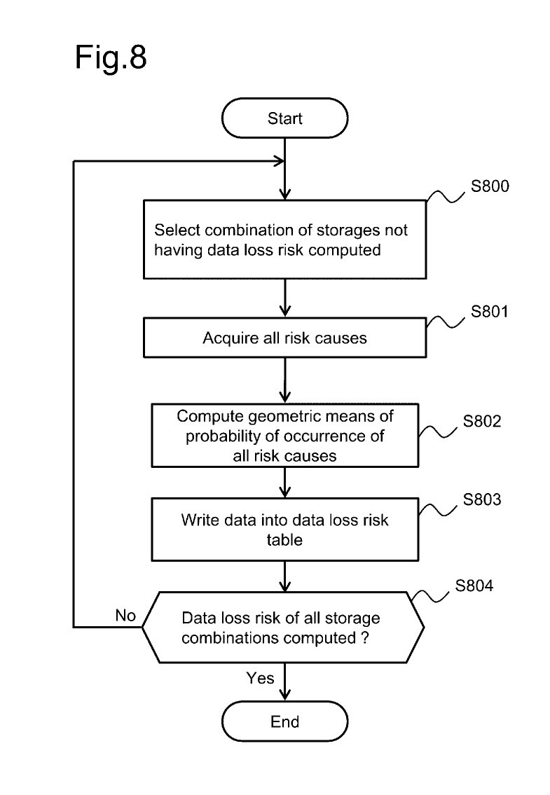

FIG. 8 is a flowchart showing the procedure for creating a data loss risk table 104. At first, the data loss risk computation program 106 refers to the data loss risk table 104 and selects a combination 300 of storage subsystems in which the data loss risk is not calculated (S800).

Thereafter, the data loss risk computation program 106 refers to the combination 200 of the data loss cause table 103, and acquires a cause 201 and a risk 202 of occurrence thereof corresponding to the combination of storage subsystems selected in step S800 (S801).

Next, the data loss risk computation program 106 computes the total risk value having totalized the risk of occurrence of multiple causes acquired in step S801. A preferable method for calculating the value having totalized the risk of occurrence of multiple causes is a geometric means (dividing the total risk value calculated by synergizing single risks of storage subsystems by the number of calculated risk values), but other methods can also be used (S802).

Next, the data loss risk computation program 106 enters the value computed in step S802 to a total risk value 301 of the row selected in step S800 of the data loss risk table 104 (S803).

Lastly, the data loss risk computation program 106 refers to the data loss risk table 104 to check whether there is a combination of storage subsystems not having the data loss risk calculated, and if there is none, ends the process (S804). According to the process illustrated above, the data loss risk table 104 can be created.

The above description is an explanation considering a case where the number of replications is 1 and all data loss causes are to be considered. If the number of replications is 2 or more, the total risk value 301 should be generated for each data loss cause designated in FIG. 7.

### <Optimum Data Allocation>

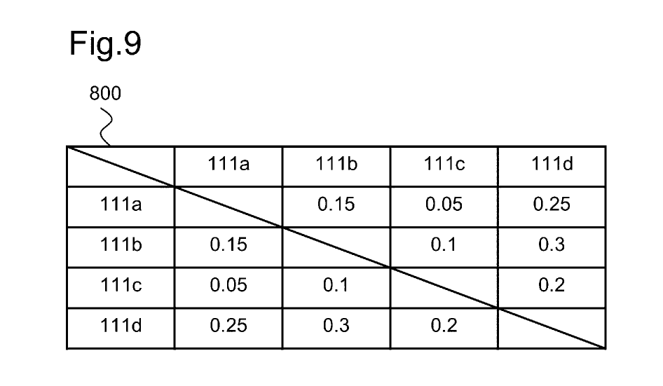

In determining the combination of storage subsystems for allocating data, it is preferable to reduce the risk of data loss of all the data, but on the other hand, it is necessary that all the data are stored within the allowable range of the capacity and performance of the respective storage subsystems. The present embodiment illustrates the procedure for computing the optimum data allocation under such conditions. The procedure for computing the optimum data allocation will be described with reference to FIG. 9.

According to the present embodiment, each storage subsystem constitutes a pair with another single storage subsystem, and a single data is allocated in each pair. By setting up such conditions, it is possible to prevent two or more data from compressing the capacity of the storage subsystems or to prevent the deterioration of the performance of the storage subsystems by having accesses to the two or more data competition one another.

FIG. 9 is a storage subsystem combination management table 800 (hereinafter referred to as subsystem combination management table 800) for computing the optimum storage subsystem combination according to the present embodiment. The storage subsystems constituting the system of the present invention is shown in order in the fields of the first line and the first row of the subsystem combination management table 800, and a total risk value of the respective combination of storage subsystems are shown in the cell at the intersection of lines and rows. Although not shown, the subsystem combination management table 800 is stored in the memory 102 of the server 100.

According to the example illustrated in FIG. 9, the total risk value of the combination of storage subsystems 111a and 111b is 0.15, the total risk value of the combination of storage subsystems 111a and 111c is 0.05, and the total risk value of the combination of storage subsystems 111a and 111d is 0.25.

Similarly, the total risk value of the combination of storage subsystems 111b and 111c is 0.2, the total risk value of the combination of storage subsystems 111b an 111d is 0.3, and the total risk value of the combination of storage subsystems 111c and 111d is 0.2.

The data loss risk computation program 106 refers to all the cells of the subsystem combination management table 800, and deletes the pair of storage subsystems in which the total risk value becomes highest. This procedure is repeated until all storage subsystems form a pair with a single storage subsystem. This computation method is considered to be the optimum computation method in that the combination of storage subsystems having a high data loss risk can be deleted. Further, if an index is used such that the data loss risk increases as the total risk value decreases, the process for deleting the pair of storage subsystems having the highest total risk value according to the above-illustrated computation method should be replaced with a process for deleting the pair of storage subsystems having the smallest total risk value.

According to the example shown in FIG. 9, the highest total risk value stored in the subsystem combination management table 800 is 0.3, so that the data loss risk computation program 106 first deletes the combination of storage subsystems 111b and 111d. Since the next highest total risk value is 0.25, the data loss risk computation program 106 deletes the combination of storage subsystems 111a and 111d. According to such process, it is computed that the optimum combination are a combination of storage subsystems 111a and 111b and a combination of storage subsystems 111c and 111d.

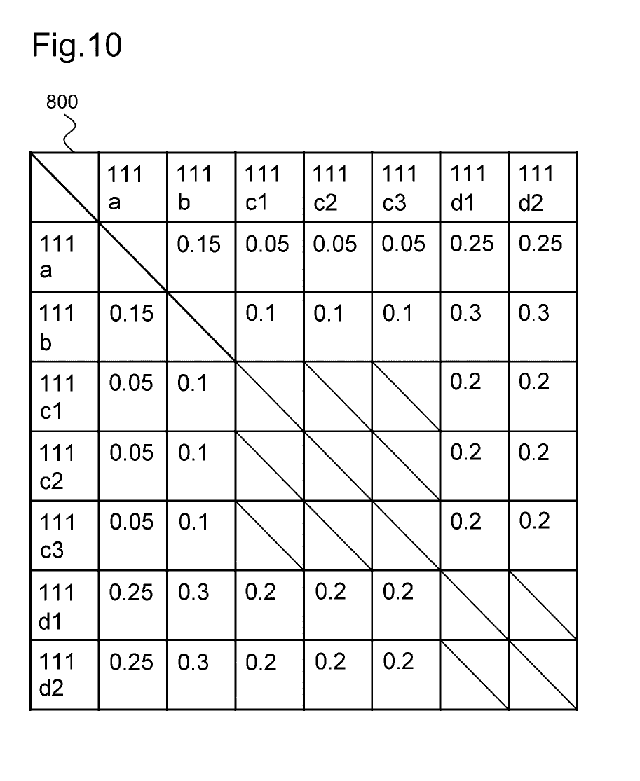

FIG. 10 is a view showing a the subsystem combination management table 800 for computing the optimum combination of storage subsystems when the rate of capacities of storage subsystems 111a, 111b, 111c and 111d is 1:1:3:2. In the example of FIG. 10, it is assumed that storage subsystem 100c is a storage composed of three storages, storage subsystem 100c1, storage subsystem 100c2 and storage subsystem 100c3, and it is assumed that storage subsystem 100d is a storage composed of two storages, storage subsystem 100d1 and storage subsystem 100d2, according to which the optimum combination of storage subsystems can be computed by the computation method mentioned earlier even if the system is composed of multiple storages having different capacities.

The total risk value of each combination of storages is similar to the description of FIG. 9, so the method for computing the optimum combination of two storages similar to FIG. 9 will now be illustrated in detail. The highest total risk value in the subsystem combination management table 800 of FIG. 10 is 0.3, so the combination of storages 111b and 111d1 and the combination of storages 111b and 111d2 are deleted.

The next highest total risk value is 0.25, so the combination of storages 111a and 111d and the combination of storages 111a and 111d2 are deleted. The next highest total risk value is 0.2, so the combination of storages 111c and 111d is deleted. Since the next highest total risk value is 0.15, the combination of storages 111a and 111b is deleted. According to such process, it becomes possible to compute that the combination of storages 111a and 111c and the combination of storages 111b and 111c are optimum.

The present embodiment has illustrated the computation method assuming that the capacities of the respective storages are provided via rates so as to reduce the number of combinations and to shorten computation time, but even if the capacities of the respective storages are provided via block units such as GB (Giga Bytes) and TB (Tera Bytes), a similar computation method can be applied by setting capacity management units and computing the rate of capacities of respective storages. For example, if a storage having a capacity of 11 TB and a storage having a capacity of 5 TB are provided, by setting the capacity management unit to 2 TB, a quotient of 5 and 2 is respectively obtained. Therefore, the ratio will be 5:2.

Next, the replication configuration computation program 107 creates a replication configuration management table 105 (FIG. 4) based on the conditions of the storage subsystems and the above-described computation result. According to the example illustrated in FIG. 9, the smaller one of the capacity of the storage subsystem 111a and the capacity of the storage subsystem 111b can be regarded as the capacity (upper limit of use) of the relevant combination, therefore, replication data is determined so as not to exceed the capacity of the combination. The storage subsystems 111c and 111d are determined in a similar manner. If priority is set for the data, the replication data is determined so that the data having a high priority is replicated to a combination of storage subsystems having a low loss risk.

Lastly, the replication control program 108 refers to the replication configuration management table 105, and orders replication to the replication program 502 of each storage. Further, when the data has an allowable risk value 402 set thereto, a combination of storages having a loss risk smaller than the allowable risk can be selected. Moreover, if all combinations of storages have a loss risk smaller than the allowable risk value, the loss risk can be reduced by increasing the number of replications before the combination of storages is selected.

Based on the above-described procedure, it becomes possible to compute the optimum data allocation. Further, the computation method for optimization described with reference to FIG. 9 is merely an example, and other methods can be used for computation. The present embodiment has illustrated an example in which each storage subsystem constitutes a pair with another single storage subsystem, and a single data is allocated in each pair, but it is also possible to perform computation based on other conditions.

The present invention has further illustrated a computation method of a non-directed graph for performing storage data replication of mutual storage subsystems, but it is also possible to acquire a digraph for setting replication source and replication destination storage subsystems in the combination of storage subsystems.

### Second Embodiment

### Billing Related to Data Replication

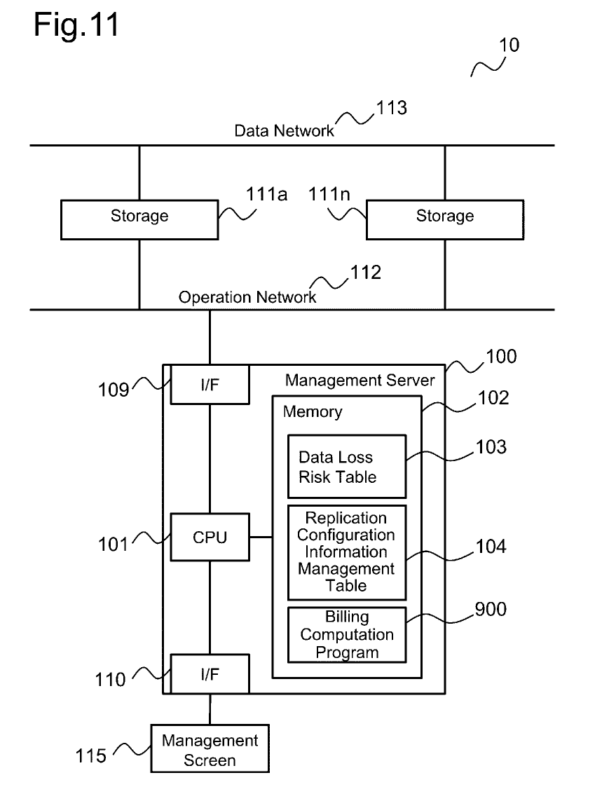

The present embodiment relates to an embodiment for calculating the billing related to data replication based on data loss risks. The billing method related to data replication based on the data loss risks according to a third embodiment of the present invention will be described with reference to FIGS. 11 through 13.

FIG. 11 is an outline of a basic computer system according to the present embodiment. In the present embodiment, in addition to the computer system of FIG. 1, a billing computation program 900 is arranged in the memory 102.

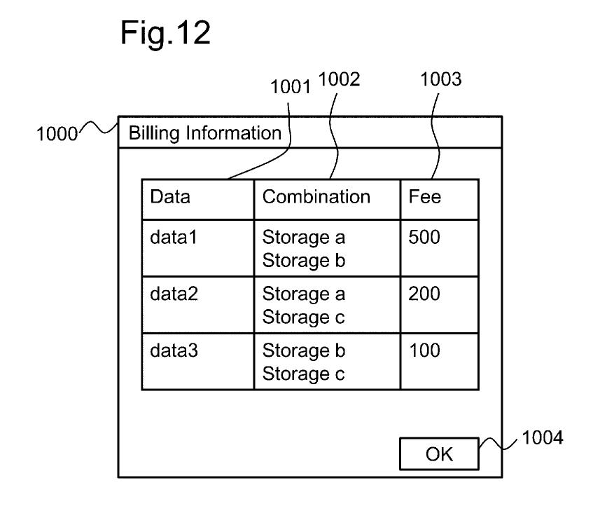

FIG. 12 shows an example of the interface of the billing information that the billing computation program 900 displays on the management screen 115 according to the present embodiment. The interface of the billing information includes, at least, a data 1001 as the target of billing, a combination 1002 in which data is allocated, and a fee 1003 calculated by the billing computation program 900.

Although not shown, the billing table is composed of data 1001, combination 1002 and a price for the total risk value. The billing table is for performing billing corresponding to the total risk value 301 per combination 300 of the storage subsystems for replicating each data. According to the present embodiment, the billing is increased for combinations having smaller risk values.

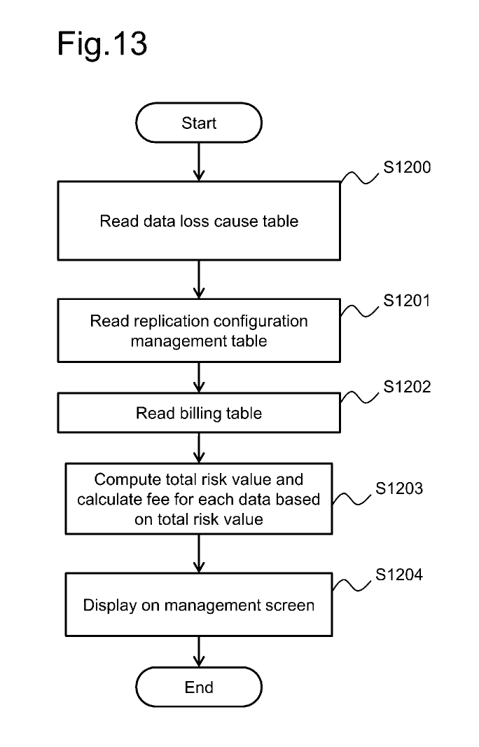

FIG. 13 is a flowchart showing the procedure the billing computation program 900 for calculating a fee regarding the replication of data according to the present embodiment.

At first, the billing computation program 900 reads the data loss cause table 103 from the memory 102 (S1201). Thereafter, the billing computation program 900 reads the replication configuration management table 105 from the memory 102 (S1202). Next, the billing computation program 900 reads a billing table 1005 created using the interface of the billing information displayed on the management screen 115 and stored in the memory 102 (S1202).

Then, the billing computation program 900 computes the total risk value according to the combination of data replication based on the read data loss cause table 103 and the replication configuration management table 105. Then, the billing computation program 900 calculates a fee 1003 regarding the replication of data based on the read billing table and the calculated total risk value (S1203).

One example of the computation method is a method for calculating a fee regarding the replication of data based on the billing method determined based on the total risk value. A billing method is generally adopted which is set so that when the total risk value is high as mentioned earlier, the billing is set low (a billing method set so that when the total risk value is low, the billing is set low).

Finally, the billing computation program 900 displays data 1001, the combination 1002 of data replication and the fee 1003 on the management screen 115, and ends the process (S1204).

### Third Embodiment

### Security

The storage subsystem of the present computer system includes a storage subsystem within the organization (private storage) and a storage disposed outside the range of the organization such as storage subsystems provided via the internet or the like (cloud storage). In such case, the data permitted to be accessed only within the organization must be stored within the private storage, but other data can be stored in the cloud storage.

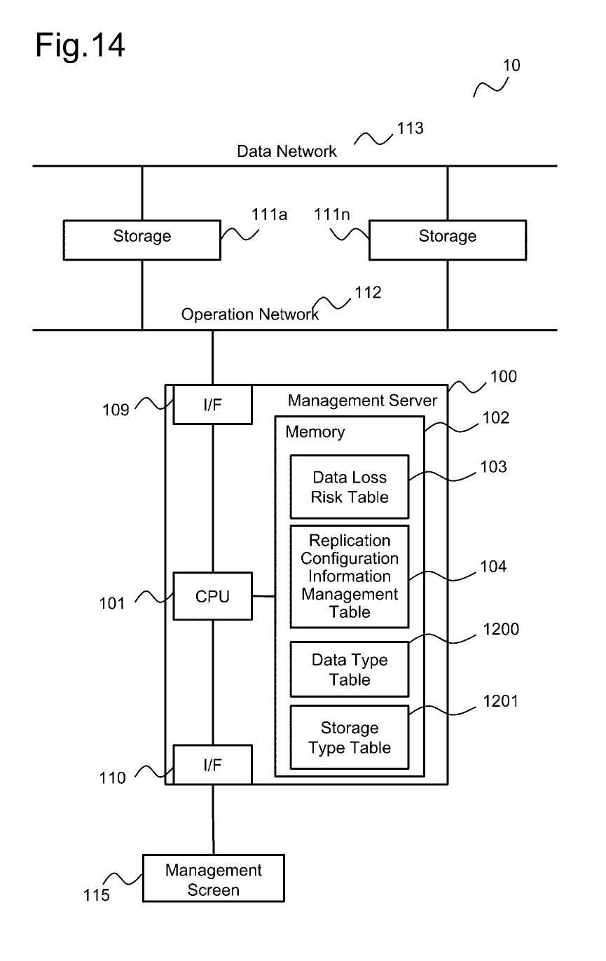

The present embodiment illustrates a process for calculating the optimum data allocation assuming that the storage subsystem capable of having data allocated is restricted according to the data type. FIG. 14 is an outline of a basic computer system according to the present embodiment. According to the present embodiment, in addition to the computer system shown in FIG. 1, a data type table 1200 and a storage subsystem type table 1201 are allocated in the memory 102.

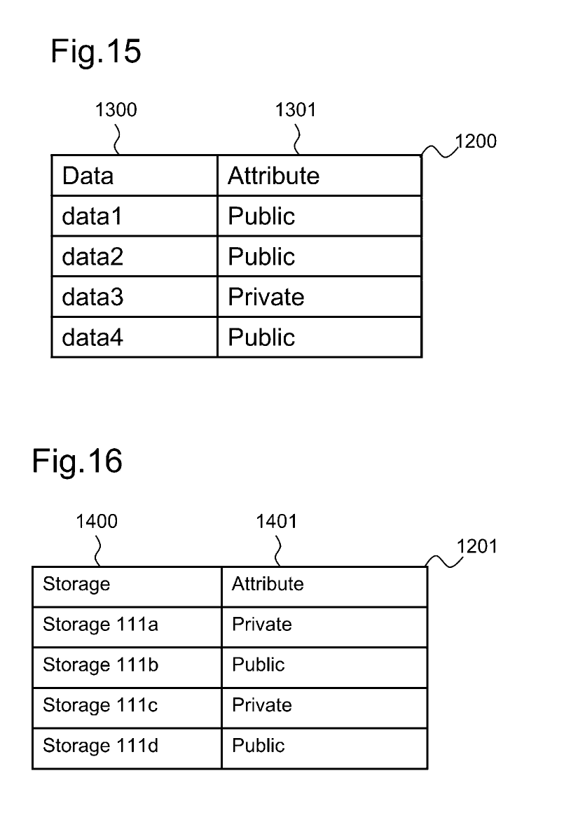

FIG. 15 shows one example of a data type table 1200. The data type table 1200 at least includes a data identifier 1300 and an attribute 1301 illustrating whether the data can be allocated in a cloud storage or not.

If the attribute 1301 is “Public”, the data can also be allocated in a cloud storage. In contrast, if the attribute 1301 is “Private”, it means that data cannot be allocated in a cloud storage, and can only be stored in a storage subsystem within the organization (private storage). For example, attribute 1301 of data 3 is “Private”, meaning that data 3 can only be stored in a private storage.

Further, the attribute 1301 of the present table can store one or more replicable organization information or one or more country information. Further, the data 1300 of the present table can store the identifier of the storage subsystem. In such case, all the data stored in the storage subsystem specified by the identifier becomes the target.

FIG. 16 is an example of a storage subsystem type table 1201. The storage subsystem type table 1201 at least includes an identifier 1400 of the storage subsystem and an attribute 1401 indicating whether the storage subsystem is a private storage or a cloud storage.

According to the example illustrated in FIG. 16, the storage subsystems 111a and 111c are private storages, and storage subsystems 111b and 111d are public storages subsystem. Further, the attribute 1401 of the present table can store organization information retaining the storage subsystem or the country information in which the storage subsystem is disposed.

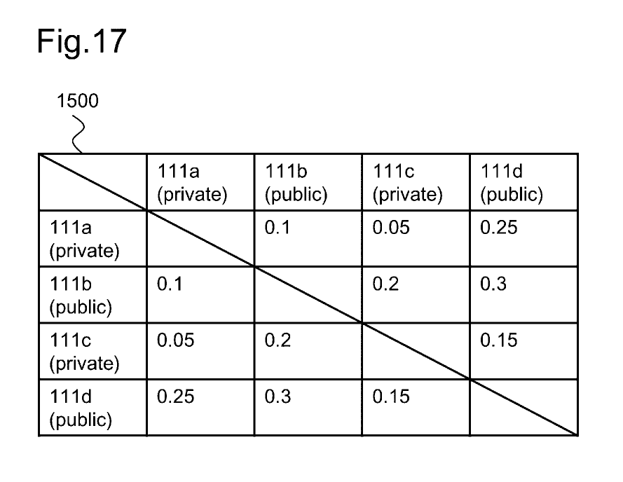

FIG. 17 is a storage subsystem combination management table 1500 (hereinafter referred to as subsystem combination management table 1500) for calculating an optimum combination of storage subsystems according to the present embodiment. The contents of the subsystem combination management table 1500 are the same as FIG. 9, but the example illustrated in the storage subsystem type table 1201 of FIG. 16 (identifier 1400 and attribute 1401 of storage subsystem) is reflected in the first row and first line.

At first, the data loss risk computation program 106 calculates an optimum combination of storage subsystems based on the subsystem combination management table 1500. In the example illustrated in FIG. 17, the computation method is similar to embodiment 1, and it is computed that the combination of storage subsystems 111a and 111b and the combination of storage subsystems 111c and 111d are optimum.

Next, the replication configuration computation program 107 creates a replication configuration management table 105 based on the conditions of the respective storage subsystems and the computation result. The replication configuration computation program 107 refers to a data type table 1200 and selects a combination of storage subsystems with respect to the data so that data that cannot be allocated in a public storage subsystem will not be stored erroneously in a public storage subsystem.

According to the example illustrated in FIGS. 16 and 17 data 3 cannot be allocated in a public storage subsystem, so that the replication configuration management table 105 is created so that the data 3 is replicated in storage subsystems 111a and 111c having the attribute 1401 set to “Private”.

Finally, the replication control program 108 refers to the replication configuration management table 105 and orders replication of data to the replication program 502 of each storage subsystem.

According to the above-described procedure, it becomes possible to compute the optimum data allocation based on the data type and the storage subsystem type. Further, the calculation method for optimization using FIGS. 16 and 17 is merely an example, and the calculation can be performed via other methods.

### Fourth Embodiment

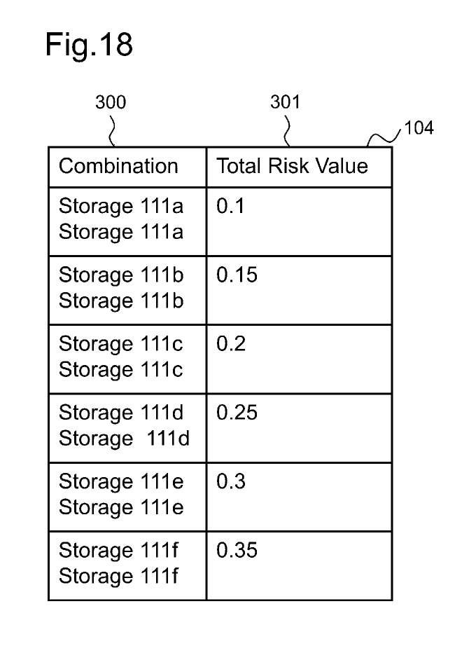

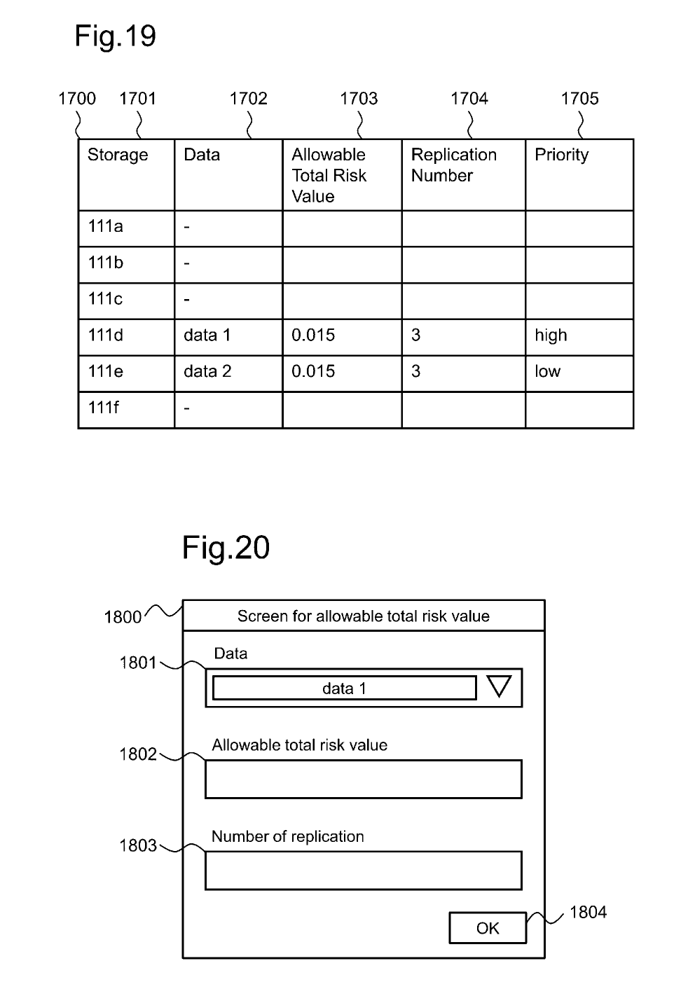

If data is stored in a single storage subsystem whose data loss risks are high, it becomes possible to reduce the data loss risk replicating the data to multiple storage subsystems. With reference to FIGS. 18 through 19, the present embodiment illustrates the procedure for computation to copy data to other storage subsystems for reducing the data loss risk to the allowable risk value the each data has. In the present embodiment, in addition to the computer system of FIG. 1, an allowable data loss risk table is allocated in the memory 102.

FIG. 18 shows one example of a data loss risk table 104. In the present embodiment, arrangement of the replicated data is computed based on a total risk value of a single storage system setting the same storage system in a combination 300. The method to compute total risk values 301 is similar to embodiment 1. In the example illustrated in FIG. 18, a total risk value of storage subsystems 111a is 0.1, a total risk value of storage subsystems 111b is 0.15, a total risk value of storage subsystems 111c is 0.2, a total risk value of storage subsystems 111d is 0.25, a total risk value of storage subsystems 111e is 0.3, and a total risk value of storage subsystems 111f is 0.35.

FIG. 19 shows one example of an allowable data loss risk table 1700. The allowable data loss risk table 1700 includes at least a storage subsystem 1701 which is a storage subsystem stored the data 1702, a data 1702, an allowable total risk value 1703 (hereinafter referred to an allowable total risk value) which is a maximum value allowed for the data 1702, and a maximum number of replications 1704 (hereinafter referred to a replication number 1704) of the data 1702. The allowable data loss risk table 1700 can further include a priority 1705. If a storage subsystem does not store data, it is possible to describe the data 1702 to a hyphen. In the example illustrated in FIG. 19, storage subsystems 111d store data 1, storage subsystems 111e stores data 2, an allowable total risk value of data 1 is 0.015, a maximum number of replications of data 1 is 3, a priority of data 1 is “high”, an allowable total risk value of data 2 is 0.015, a replication number of data 2 is 3, and a priority of data 2 is “low”. The priority of data is also suitable a number increased for the priority.

According to the present embodiment, a single data is allocated in a single storage subsystem. By setting up such conditions, it is possible to prevent two or more data from compressing the capacity of the storage subsystems or to prevent the deterioration of the performance of the storage subsystems by having accesses to the two or more data competition one another.

FIG. 20 shows an example of the screen interface 1800 for entering an allowable total risk value, a maximum number of replications, and a priority of each data. The screen interface 1800 at least includes a select field 1801 for selecting data, an entry field 1802 for entering an allowable total risk value of the data, an entry field 1803 for entering a replication number of the data. The screen interface 1800 can further include an entry field for entering the priority of the data. The screen interface 1800 is displayed by the data loss risk computation program 106 on the management screen 115, and an administrator enters the above values using the screen interface 1800.

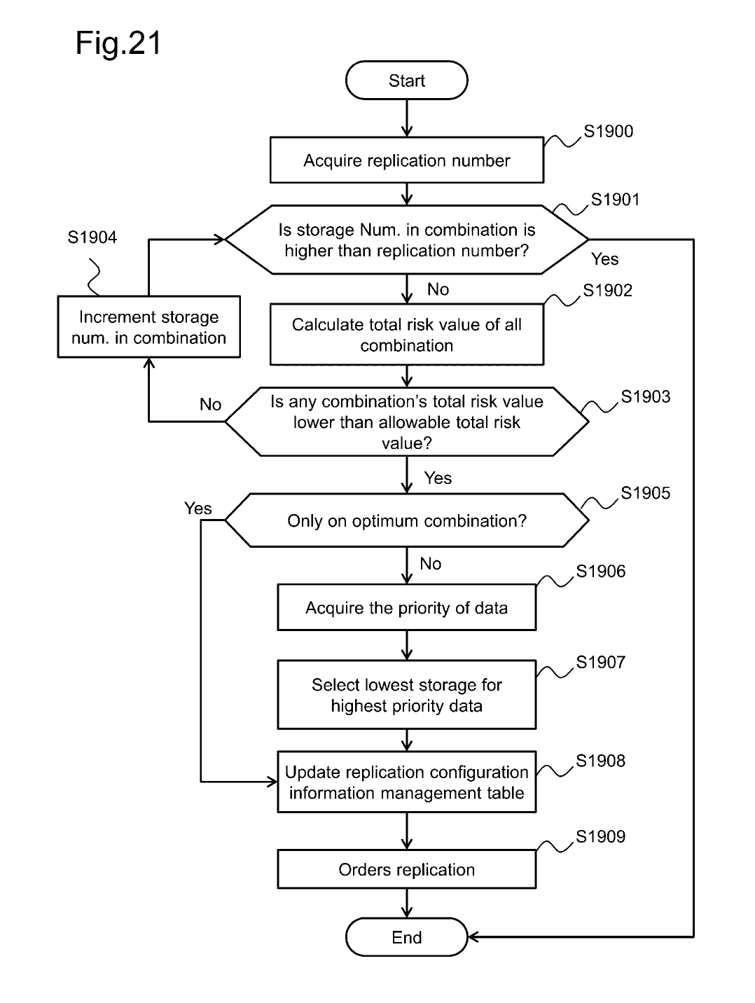

FIG. 21 is a flowchart showing the procedure for calculating an optimum replication an arrangement of the replicated data. At first, the data loss risk computation program 106 refers to the allowable data loss risk table 1700, and acquires the maximum replication number of all data (S1900). In the example illustrated in FIG. 19, the maximum replication number is 3. If the data stored in the storage subsystem which has lower total risk value than the allowable total risk value of the data stored in, the procedure illustrated in FIG. 21 is not mandatory.

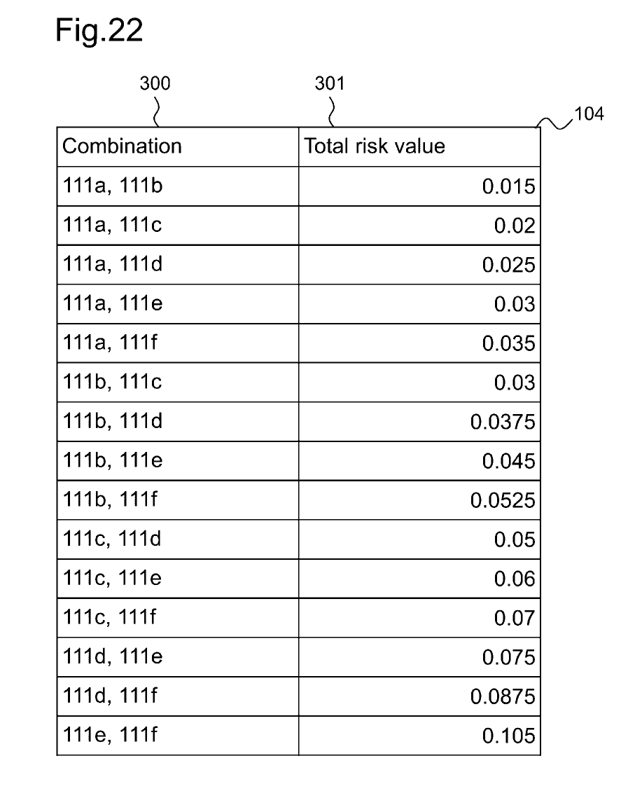

Next, the data loss risk computation program 106 checks the number of storage subsystems included in one combination (S1901). If the number is larger than the maximum replication number, ends the process (S1901: No). If the number is the maximum replication number or below, the data loss risk computation program 106 refers to the data loss risk table 104, and calculates total risk value of all combination of storage subsystems. Then the data loss risk computation program 106 append these combinations and the total risk values to the data loss risk table 104(S1902). For example, the method to calculate total risk value is to multiply total risk values of each storage systems. The default number of storage subsystems included in one combination is 2. FIG. 22 shows one example of a data loss risk table 104 after appending all combinations constituting two storage subsystems and their total risk values based on the examples illustrated in FIGS. 18 and 19.

Next, the data loss risk computation program 106 refers the data loss risk table 104, and checks whether there are one or more combinations which have lower total risk value than the allowable total risk value of each data (S1903). In the example of FIG. 19, the data loss risk computation program 106 select the combination including storage subsystem 111d for data 1, and the combination including storage subsystem 111e for data 2. If there are not the combination which satisfies the conditions (S1903: No), the data loss risk computation program 106 increments the number of storage subsystems included in one combination then goes back to S1901 (S1904). In the example of FIGS. 18 and 19, if the combination including two storage subsystems, there are not the combination which has lower total risk value than the allowable total risk value of each data. The data loss risk computation program 106 executes S1904 (i.e. the number of storage subsystems included in one combination is three), then re-executes S1901 through S1903.

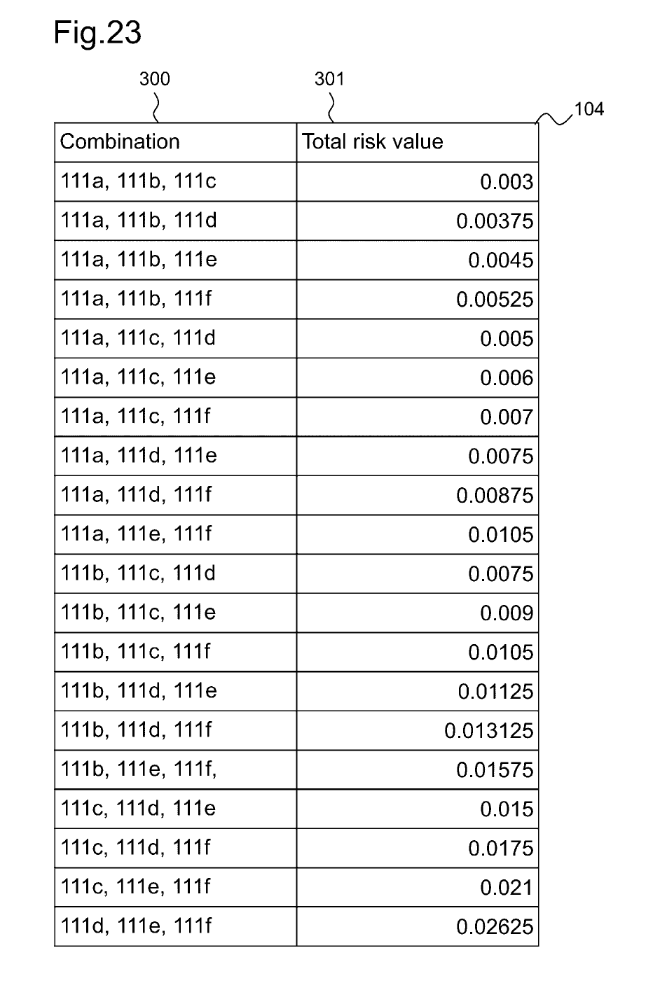

If there are one or more combinations which have lower total risk value than the allowable total risk value of each data (S1903: Yes), and if there are two or more combinations which has lower total risk value than the allowable total risk value of each data (S1905: No), the data loss risk computation program 106 refers the allowable data loss risk table 1700 and acquires the priority 1705 of each data (S1906). FIG. 23 shows one example of a data loss risk table 104 after appending all combination constituting three storage subsystems and their total risk values based on the examples illustrated in FIGS. 18 and 19. In the example illustrated in FIG. 23, One of the optimum combinations is replicating data 1 to storage 111a, storage 111d and storage 111f, and replicating data 2 to storage 111b, storage 111c and storage 111e. Another optimum combination is replicating data 1 to storage 111b, storage 111d and storage 111f, and replicating data 2 to storage 111a, storage 111c and storage 111e. In this case, the data loss risk computation program 106 selects the combination that the data which has the highest priority is stored in the storage subsystem whose total risk value is the lowest (S1907). In the example illustrated in FIG. 19, the priority of data 1 is higher than data 2, and storage 111a's total risk value is the lowest, then the optimum combination is replicating data 1 to storage 111a, storage 111d and storage 111f, and replicating data 2 to storage 111b, storage 111c and storage 111e. In the present embodiment, the data loss risk computation program 106 determines the optimum combination using the priority of each data, but the data loss risk computation program 106 can use organization information of each storage subsystems and determine that same data is stored the storage subsystems which belong to same organization. For example, If an organization has storage 111b and storage 111d, the optimum combination is replicating data 1 to storage 111b, storage 111d and storage 111f, and replicating data 2 to storage 111a, storage 111c and storage 111e (S1907).

Next, the replication configuration computation program 107 creates a replication configuration management table 105 based on the conditions of the storage subsystems and the above-described computation result (S1908).

Lastly, the replication control program 108 refers to the replication configuration management table 105, and orders replication to the replication program 502 of each storage (S1909).

As described according to the four embodiments, a computer system capable of optimizing the data allocation (replication relationship) in a storage subsystem capable of reducing the risk of data loss even when a widespread disaster occurs and a plurality of storage subsystems are damaged can be constructed by considering the replication of data.

Another possible embodiment of the present invention can take into consideration the access performance of data for placing the data. It is possible to consider a location from where a certain data is most accessed and to locate either the relevant data or the replication data in a location having a good access performance from the area where the most access occurs. Moreover, not all the data are normally accessed, so that the access performance of only specific data such as those having high accesses can be taken into consideration.

The primary object of the present invention is to reduce data loss risks, but there also exists an access temporarily disabled risk in which during disaster, data is not lost but data access is temporarily disabled since the network is disconnected. If data is located at a distant location from the area where data is most accessed, the risk of the network being disconnected is high so that the risk of having access temporarily disabled increases. Therefore, as a secondary object of the present invention, the access performance mentioned earlier can be considered during data placement so as to reduce the access temporarily disabled risk.

### REFERENCE SIGNS LIST

10 Computer system
100 Management server
101, 500 CPU
102, 501 Memory
103 Data loss cause table
104 Data loss risk table
105 Replication configuration management table
106 Data loss risk computation program
107 Replication configuration computation program
108 Replication control program
109, 503 Operation I/F
110 Screen I/F
111 Storage subsystem
112 Volume
113 Operation network
114 Data network
115 Management screen
200, 300, 401 Combination
201 Cause
202 Data loss risk
301 Total risk value
400 Data
502 Replication program
503, 504 Interface
601, 603 Entry field
602 Column
800 Subsystem combination management table
900 Billing computation program
900 Data
1002 Combination
1003 Fee
1200 Data type table
1201 Storage subsystem type table
1300 Data
1301 Attribute
1400 Identifier
1401 Attribute
1500 Subsystem combination management table
1601 Entry field
1602 Area
1603 Entry field
1604 Weight
1700 Allowable data loss risk table
1701 Storage subsystem
1702 Data
1703 Allowable total risk value
1704 Maximum number of replications
1705 Priority
1800 Interface
1801 Select field
1802, 1803 Entry field

1. A computer coupled to three or more storage subsystems, wherein the computer is composed of:
an input unit for entering information; and
a control unit;
and wherein based on the information, the control unit is caused to compute a data loss risk for each combination of storage subsystems when two or more storage subsystems out of the three or more storage subsystems are combined to store the same data, and determine a destination of arrangement of the replicated data based on the combination of the storage subsystems in which the data loss risk becomes smallest.

2. The computer according to claim 1, wherein the control unit is caused to store each storage capacity information of the three or more storage subsystems respectively in a memory device disposed on the computer or a disk array subsystem coupled to the computer; and
determine the destination of arrangement of the replicated data so that the respective storage capacities of the three or more storage subsystems are not exceeded.

3. The computer according to claim 1, wherein the control unit is caused to manage the data loss risk allowed for each data; and
determine the allocation destination of the replicated data so as not to exceed the allowable data loss risk.

4. The computer according to claim 1,
wherein the control unit to compute a data loss risk when stored the data in one storage subsystem of the three or more storage subsystems;
determine the combination of two or more storage subsystems so that the data loss risk of stored the data in one storage subsystem of the three or more storage is lower than the allowable data loss risk; and
replicate the data to the all storage subsystems included in the combination.

5. The computer according to claim 1, wherein the control unit is caused to compute the risk for each of two or more data loss causes.

6. The computer according to claim 4, wherein the control unit is caused to gather data loss causes so that the number of causes equals the number of replication of data when the number of replication of data is smaller than the number of data loss causes.

7. The computer according to claim 1, further comprising a control unit for calculating fees; and
the control unit calculates fees for replicating data according to the risk of losing data.

8. The computer according to claim 3, further comprising a control unit for managing priority of each data.

9. The computer according to claim 3, further comprising a control unit for managing data type and storage subsystem type.

10. A method for controlling a computer of a computer system composed of a storage subsystem having a control unit for replicating data among a plurality of storages, and three or more storage subsystems having a volume, and
a computer having a control unit for managing a replication relationship of data, and a control unit for ordering replication of data to the storage subsystem, wherein
the computer manages a risk of losing data for each replication relationship of data.

11. The method for controlling a computer according to claim 10, wherein each storage capacity information of the three or more storage subsystems is stored respectively in a memory device disposed on the computer or a disk array subsystem coupled to the computer; and
the destination of arrangement of the replicated data is determined so that the respective storage capacities of the three or more storage subsystems are not exceeded.

12. The method for controlling a computer according to claim 10, comprising:
managing the data loss risk allowed for each data; and
determining the allocation destination of the replicated data so as not to exceed the allowable data loss risk.

13. The method for controlling a computer according to claim 10, comprising:
computing a data loss risk for each combination of storage subsystems when two or more storage subsystems out of the three or more storage subsystems are combined to store the same data; and
determining a destination of arrangement of the replicated data based on the combination of the storage subsystems in which the data loss risk becomes smallest.

14. The method for controlling a computer according to claim 10, wherein the risk is computed for each of two or more data loss causes.

15. The method for controlling a computer according to claim 14, wherein data loss causes are gathered so that the number of causes equals the number of replication of data when the number of replication of data is smaller than the number of data loss causes.
